(19) United States
(12) Patent Application Publication
(10) Pub. No.: US 2007/0210659 A1
(43) Pub. Date: Sep. 13, 2007

(54) Radial magnetic cam

(76) Inventor: Johnny D. Long, Knoxville, TN (US)

Correspondence Address: Johnny D. Long, Apt. 1, 3305 Tazewell Pike, Knoxville, TN, 37918-2521, US

(21) Appl. No.: 11/602,001

(22) Filed: Nov. 20, 2006

Related U.S. Application Data
(60) Provisional application No. 60/780,004, filed on Mar. 7, 2006.

(51) Int. Cl. H02K 7/06; H02K 49/00; H02K 7/10; H02P 15/00

(52) U.S. Cl. 310/80; 310/103

(57) ABSTRACT

A non-contact magnetic motion converter or magnetic cam comprises a permanent magnet rotational element or assembly having a pre-selected magnetic field shape, profile, and radial position in relation to the rotational axis and provides a continuous, operatively radial magnetic work-space comprising at least one continuous and non-sequential magnetic field area in accordance with the pre-selected field profile, radial position, and work-space. The operative radial work-space and permanent magnet rotational element or assembly is supported for rotational motion about an axis perpendicular to the radial work-space and provides a leveraging displacement aspect in accordance with the radial magnetic work-space profile or position relative to the rotational axis. At least one permanent magnet reciprocating element or assembly, having a pre-selected size and shape, provides a magnetic work-space comprising at least one magnetic field area and is supported for reciprocating motion along a plane substantially perpendicular to the rotational axis of a permanent magnet rotational element or assembly and adjacently or within a radial work-space herein described.

### CROSS REFERENCE TO RELATED APPLICATIONS

This application claims the benefit of U.S. Provisional Application No. 60/780,004; filed Mar. 7, 2006.

### STATEMENT REGARDING FEDERALLY SPONSORED RESEARCH OR DEVELOPMENT

Not Applicable.

### BACKGROUND OF THE INVENTION

1. Field of Invention

The invention relates generally to friction-based devices such as mechanical cams and followers, yokes, cranks, and links for power and motion conversion between rotating and reciprocating motion and relates generally to magnetic motion conversion devices as known in the art. More specifically, the invention relates to significant friction and wear reduction and efficient conversion of rotational and reciprocating motion by utilizing the force of magnetic field areas along an equatorial plane and work-space shared by at least one continuous, non-sequential, radially operative field area of a permanent magnet rotational element or assembly and at least one of a permanent magnet reciprocating element or assembly having a magnetic field area wherein one follows or actuates the other without cogging, field switching, or magnetic force disconnects; and further relates to embodiments wherein working elements may be isolated or hermetically sealed there between.

2. Description of Related Art

Friction-based mechanical cams or cam slots with cam followers, crank shafts, and scotch-yoke devices with cams or crank-pins have for many years been used for converting rotary and reciprocating motion. The prior art is replete with such devices and it has been given to the field of tribology to analyze wear rates and to predict the useful life of these friction-based mechanisms. Various bearings, bearing surfaces, linkages, and pre-load arrangements have been utilized and gradually improved upon in the quest for efficient and robust conversion of motion while attempting to reduce losses to friction and noise. Such devices have found use in a broad range of applications including motors, pumps, generators, material handlers, and robots, as well as in devices such as Stirling cycle engines, acoustic engines, and other devices having pistons, piezo elements, electro-magnetic coils, expandable membranes, and shape memory alloys where such devices require conversion between reciprocating and rotational motion. Variations on the scotch-yoke device, because of its return position ability, have possibly found the broadest usage; and, since the device converts pure linear motion, it is also being further developed for use in automobile engines to alleviate the problem of angular crank shaft rods that cause piston wear against cylinder walls.

Mechanical cams come in many shapes including pear-shaped, heart-shaped, eccentric circular, off-set circular, multiple lobe, and groove. Various cam follower shapes have included blade-type, rollers, and flat foot or mushroom shapes. Mechanical cam systems have been versatile because almost any specified motion can be obtained. Dimensional and displacement calculations are normally used to determine a cam contour to deliver a specified motion within an acceptable velocity. In most mechanical cam systems is it important that the cam and follower be in constant contact. This usually requires a cam follower with a spring, pre-loaded bearings, or designed loads to maintain constant contact between the moving surfaces. A mechanical edge or face cam, wherein the follower is in contact with the edge of the cam, is only capable of imparting positive motion to its follower in one direction during the rise portion of the cam movement. During the fall portion the follower must be maintained in contact either by gravity, a spring, or some other device to provide a return means for the reciprocating follower. All of the various types of mechanical cams, crank pins, and followers exhibit problems of friction and wear, along with noise, due to the forces of physical contact between working elements and wear resulting in the loss of close tolerances which in turn produces more wear at a faster rate. The return-means problem or aspect, however, was partially solved by the construction of mechanical cam slots and mechanical scotch-yoke mechanisms. Even so, these devices require some method for maintaining constant contact between the elements to avoid noise, slapping, galling, and skipping. To minimize these problems complex and expensive designs have been required.

Typically, scotch-yoke mechanisms have an off-set crank-pin or cam rotatable within a yoke or a crank-pin rotates inside a shuttle that slides within a yoke member in such a way that the shuttle follows a rectilinear path as the crank pin turns, thus converting rotary and reciprocating motion. The yoke-type structure, whether used with a crank-pin or a cam, generally provides return means for the reciprocating element by physically capturing the rotating crank pin or cam within an elongated aperture. Although the motion conversion in such cases is direct and robust, these devices suffer from excessive friction and wear, need constant lubrication, and exhibit material fatigue and failure. In the end friction prevails.

Aside from strictly mechanical devices, there are numerous examples in the prior art for conversion between rotary and reciprocating motion wherein magnetic fields are utilized. Due to the availability and substantial cost reduction of high energy-product permanent magnets such as neodymium and samarium cobalt, such magnets are now finding wide use in numerous applications including magnetic motion conversion. It has been shown that various types of motion, previously converted by mechanical and friction-based devices, can be converted without physical contact and that there is a potential for a great reduction in mechanical losses. Non-contact, reciprocating and rotary motion conversion represents a departure from friction-based systems, moving beyond a simple magnetic coupling between shafts or coupling between magnetic gears, by converting two different types of motion. The prior art, however, has not shown progress in this field and those devices have not found broad usage due in part to excessively complex designs.

Examples in the prior art show attempts to efficiently convert rotary and reciprocating motion by utilizing permanent magnets. Many of the devices are not operationally reversible; so that, for example, a device that converts reciprocating motion to rotary motion is not able to convert rotary to reciprocating motion or vice versa. Such devices; often complex, ineffective, or ponderous, have made use of both the attraction and repelling forces between magnetic elements or have used only attraction forces. Typically a reciprocating magnetic element is actuated between two positions to alternately attract and repel step-wise increments of a symmetric rotor having a plurality of alternating field magnets or magnetic segments that provide intermittent, sequential, or discontinuous fields between concentrically placed magnets to cause rotation. Because of the sequential alternating fields, discontinuous fields, or construction, the forces required in such devices are known to produce positions of magnetic disconnect, field crossing, and adverse cogging positions. Even the few devices that attempt to balance or design around the problem have required a magnetic disconnect between the reciprocating magnet and alternating or discontinuous field sections of the rotor, otherwise excessively complex schemes have been employed. Such devices usually suffer from efficiency losses that outweigh their advantages and do not scale efficiently to various sizes. At meso-scale for example, where space constraints dictate acceptable designs, the ability to manufacture devices in miniature will only endure highly efficient and simple designs. Also, at larger scales robust and efficient designs have not been provided. Magnetic motion conversion in the prior art has not only shown a history of excessively complex or awkward devices but often a basic misunderstanding relating to the nature of magnetic fields.

Mu et. al.; U.S. Pat. No. 6,731,035 (2004), discloses a magnetic apparatus for generating “autogenic” energy, including a base, a first magnetic device, a second magnetic device, and a transmission member. There is a linking member with the transmission structure for moving the first magnet toward and away from the second rotational magnet in response to rotation of the transmission so that the repelling force varies when the magnets move within intermittent proximity to each other and sequentially progress to reach a pass-by position between positive and negative forces. A magnetic force disconnect is required within the sequence at the magnetic cross-over positions. The intermittent sequence of placing the repelling magnet in proximity to another magnet along a shaft relies on a displacement force that decreases with distance. Although the device attempts to provide self-actuating, autogenic response “without being stopped by the negative force, friction, or even a load applied to the output”, the device appears to be no more efficient or effective than a standard flywheel. It should be understood by those skilled in the art that under most conditions magnetic fields adhere as strictly as mechanical devices do to the laws of the conservation of energy and that magnetic fields and forces most often do not conform at first glance to visual content.

U.S. Pat. No. 6,274,959; to Uchiyama (2001), discloses a rotatable symmetric disk having a magnetic alley with a plurality of sequentially spaced magnets arranged along the perimeter. The reciprocal device has a second magnet alley with magnets in association with the first magnets. A magnetic disconnect occurs as the reciprocating magnets move between two positions to attract and then repel alternating magnetic fields on the disk, thus causing rotation. By a particular construction and spacing arrangement in one embodiment, the device attempts to balance the cogging or counter-productive magnetic forces that occur during the magnetic disconnect and the step-wise perimeter sequence.

Similar to Uchiyama, U.S. Pat. No. 6,433,452; to Graham (2002), discloses a rotatable balance wheel with multiple sequential permanent magnets spaced and affixed to the outer periphery and a permanent magnet affixed to a power rod so that alternating magnetic fields on the balance wheel come into intermittent proximity with the reciprocating power rod magnet by way of a mechanical timing cam. Reciprocating magnetic forces cause incremental rotation of the output shaft. In an attempt to alleviate the problem of cogging and disconnect imposed by the alternating forces of attraction and repulsion a shield member is installed “to prevent significant interference from positive and negative pole faces”.

U.S. Pat. No. 4,207,773; to Stahovic (1980), discloses a magnetic piston machine that converts rotary motion to reciprocating linear motion utilizing a plurality of spaced alternating magnetic field segments fixed to a rotary member. The device is not reversible. A pair of reciprocating magnets outside the rotor, each on opposite sides and coaxially connected, interacts magnetically with the alternating rotor magnet segments. As one magnet is repelled on one side, the other is attracted on the other. This arrangement of combined forces, pushing on one side while pulling on the other, attempts to increase the linear driving force by relying entirely on the displacement forces of the magnetic fields. To reduce the excessive magnetic cogging that occurs due to the intermittent centered force of attraction on one side along with an intermittent repelling force centered through the rotor axis on the other, additional stationary magnets are provided to repel the reciprocating magnets at the outer travel limits and to somehow balance the negative force. However, due to the segmented diametric alignment of forces centered through the rotor axis and reliance on the field strength of the magnets, the repelling force on one side does not balance, counter-balance, or diminish the attraction force on the other side and excessive cogging therefor occurs, requiring additional torque to be applied to the rotor in order to break away or disconnect from the force of attraction. The method of providing additional stationary magnets, instead of balancing the forces, merely adds resistive load to the linear output, similar to having return springs on both sides of the reciprocating linear member. The use of combined forces in this case to increase linear output is negated by the additional torque required in the rotor during the magnetic disconnect to overcome both the cogging and the additional load imposed by the stationary magnets. As noted by the inventor, “the force required to turn the crank is not directly related to the load being driven”. This is certainly true for this arrangement. The force required is dependent on the strength of the magnetic fields; as also, the linear displacement distance depends entirely on the field strength of the magnets.

Magnetic forces of attraction and repulsion, along with linear displacement between magnetic fields, must be properly understood and accounted for in the design of magnetic devices. Magnetic forces diminish exponentially with distance and are similar in this regard to mechanical springs. Oftentimes, however, magnetic force potential is confused with actual displacement distance.

A closer look at this and additional issues continues. It would appear that Stahovic's motion converter, intermittently utilizing attraction and repulsion to increase linear output, was possibly offered as a solution to a problem previously revealed by Kiniski; U.S. Pat. No. 3,811,058 (1974), which will be discussed below. Meanwhile, Stahovic's device also seems to embrace the notion posed by Putt; U.S. Pat. No. 3,992,132 (1972), that in-line and diametrically opposed magnets about the perimeter of a segmented magnetic rotor having alternating fields could somehow balance and cancel out the adverse cogging effect imposed by the alternating and sequential fields. Although similar to Stahovic's device, in Putt's device the diametrically opposed reciprocating magnets are not connected to each other. They move independently, so that as one is attracted to a return position the other is being independently repelled on the other side. In view of the cogging in Putt's device and almost as an afterthought, Putt states however that: “inasmuch as attracting forces are greater than repelling forces, it is preferred that the repelling secondary magnets be more powerful than their attracting counterparts”, all the while Putt ignores the problem that the displaced repelling magnets are caused to move to positions having an increased air gap relative to the rotor magnets and thus a decrease in force proportional to the distance occurs. Since the fields are alternating and sequential, and the forces are operative through the rotor axis, changing the field strength on either side merely causes a greater resistance to alignment of the repelling forces under a load. Moreover and again, the displacement distance in Putt's device depends entirely on the strength of the magnetic fields and provides no other leveraging or displacement aspect. Even so, the solutions proposed by Stahovic over both Putt and Kiniski were mostly ineffective and it remains that none of these three devices are reversible to convert reciprocating motion to rotary motion. Reversibility of a device speaks to both efficiency and direct conversion of motion in a way that dissection and comparison of components cannot. Nonetheless, it is worth taking a further look at the Kiniski patent having described very similar arrangements shown by Putt and Stahovic; most notably, permanent magnets and alternating or sequential field sections concentrically placed about a rotor and movement of the rotor to positions of sequential and intermittent proximity with peripherally arranged reciprocating magnets. The Kiniski rotor utilizes repelling forces along a discontinuous arc segment of a concentric rotor and relies solely on the field strength of the magnets to cause displacement of the reciprocating magnets. The structure will be explained below in reference to FIG. 19.

Kiniski's device, U.S. Pat. No. 3,811,058 (1974), comprises at least one cylinder in an engine block 700 that is open bottomed and has a magnetic piston 720 slidably disposed therein with a magnetic pole surface disposed at the bottom opening of the cylinder for selective periodic magnetic repulsion interaction with a rotary disc. The rotary disc 710, having a planar surface is mounted for rotation directly beneath the bottom cylinder opening. Fixed magnetic elements 730, 731, 732, 733, and 734, are disposed at the disc perimeter as an arc segment of slightly less than 180 degrees and are oriented for magnetic repulsion of the magnetic piston when selectively rotated to align with the piston. In this device, although there is constant repelling force provided along the arc segment, the remaining 180 degrees or greater of disc surface provides no repelling force. By utilizing a concentric arc segment the repelling force of the rotatable disc is also sequentially and selectively discontinuous and results in a magnetic force disconnect throughout the remaining unusable areas of the disc where an air gap between the magnetic forces is increased and the working field is discontinued. The device will only produce stop-motion in the reciprocating magnetic piston while the disc rotates through each 180 degree interval. Even by adding more cylinder units and piston magnets that would be connected to a common crankshaft 705 in the side view drawing, along with respectively additional magnetic discs that would be 180 degrees out of phase, the same stop motion occurs because the design does not accommodate phases between up and down positions of the pistons. Regardless of the number of pistons or number of 180 degree phases, a flywheel must be used to rotate the shaft beyond dead top and dead bottom centers. For the same reasons discussed, this device would not be effective in reverse operation for converting reciprocating to rotary motion. Moreover, there is an inherent problem of load verses piston travel due to a sole reliance on the field strength of the magnets for displacement of the piston. Although, as stated by the inventor, a stationary magnet of sufficient mass and energy product can repel another magnet 500 times its weight, this does not of itself correspond to a distance of linear travel displacement of a magnet but merely represents an amount of weight or force that can be displaced without the magnets contacting one another. An amount of force required to place a repelling magnet in proximity to a second magnet represents a force potential that is not sufficiently utilized in this prior art device. In a mechanical sense magnetic fields are not so mysterious and may be viewed as expandable or compressible springs wherein the force, in the case of repelling magnetic fields, decreases exponentially with distance as also in the case of attracting fields. Application of a load with regard to Kiniski's device merely compresses the “spring” and shortens the linear travel of the piston magnet which in this prior art device may not be properly accommodated for by an amount of off-set in the crankshaft.

Similar to the Mu patent, Kiniski intimates that a low energy input provides a large energy output and attempts to illustrate this in the example with the rotary to linear conversion device further connected to a rotary output by way of a crankshaft in a rotary-to-linear-to-rotary arrangement; however, there is no mechanical advantage that occurs between a given amount of torque applied to the rotating disc and the resulting linear excursion force of the piston or further rotary output, except in cases as described where a large gear connected to the disc is driven by the small gear of a motor. The use of magnets in such an arrangement, and for the purpose described, becomes meaningless as any mechanical advantage would be produced entirely by the gearing.

In contrast to Kiniski and the other mentioned prior art with regard to the operation and possible embodiments of the present invention, a force required, for example, to place or maintain a repelling magnet in proximity to another magnet simply represents a pre-load or bounce-space in conjunction with an additional displacement aspect. In the various embodiments of the present invention operational displacements are not solely dependent on the field strength of magnets. Magnetic flux density, surface area, and orientation provide resistance to physical contact in terms of a force amount or a potential load prior to the leveraging displacement aspect provided by the associated components along with the selectable shape, selectable position in relation to the rotational axis, and the magnetic work-space.

There has been a continuing need and objective in the field of motion conversion for improvements and alternatives that offer greater wear resistance and reduced friction while minimizing lubrication requirements. Competing objectives and concerns have become most prominent, for example, in designs for Stirling cycle engines, pumps, thermoacoustic devices, and power generators where there have been unavoidable trade-offs between low friction and durability verses greater power factors. On one hand, to reduce friction and lubrication requirements while providing durability in a Stirling engine, rotary alternators which require friction-based mechanical motion conversion from the pistons have been replaced by linear alternators that provide much lower power factors and create other problems. Due to the limit of wire size and multiple compact coils in a linear alternator, the resulting voltage spikes-create waveforms that approach the characteristics of “noise” and must be constantly monitored, conditioned, and tuned within the narrow bandwidth, thus putting a large demand on electronic components. Attempts to improve the efficiency of linear alternators have shown minimal results. Increasing the mass of a magnetic translator to increase output, for example, results in decreased oscillatory speed of the machine and thus the output. Also, since the magnetic translator has to be stopped at each excursion of travel and change directions, it is continuously accelerating and decelerating and is thus incapable of producing a sustained optimal output. On the other hand, while a rotary alternator has no need to stop and change directions and is more desirable in terms of output, there has been the continuing problem of durability and frictional losses in the process of mechanical motion conversion along with problems of lubrication, sealing, intermixing of fluids or gases, and fouling of regenerator components. Comparing the advantages and disadvantages of these two approaches, it appears that an optimal device in this case would use a rotary alternator that is sealed outside the system without shaft penetrations or shaft seals and utilize a thru-wall, non-contact magnetic motion converter or magnetic cam as provided by an embodiment of the present invention providing the least possible amount of friction in the conversion between reciprocating and rotary motion. This example is only one among many where particular embodiments of the present invention could be used to advantage.

Emerging actuator technologies such as piezo and shape memory alloys, in order to convert between linear reciprocating and rotary motion, have still been required to use inefficient mechanical systems and would also benefit from embodiments of the invention.

At small scale sizes, new and promising magnetic shape memory (MSM) alloys being developed by industry have shown shape displacements often percent in the materials and cycle times less than a millisecond and uses being investigated are devices that produce linear motion with amazing force per volume ratios. The MSM element, a moving mass, and spring return are the basic components of these actuators that may operate at high frequencies and large strokes without element fatigue. MSM actuators show power outputs far exceeding those of electric motors and are comparable to the outputs of an internal combustion engine without the weight, size, or complexity. Use of such actuators in conjunction with an embodiment of the present invention for converting linear to rotational motion would enable vastly improved, high torque rotational devices at a very small scale and without complexity; for example, meso-copters, miniature surveillance hovercraft, or terrain-rovers could be constructed having rotary drives with improved power-weight ratios. These types of actuators are also being developed for larger scale devices.

### SUMMARY

A magnetic motion converter, or radial magnetic cam, comprises a permanent magnet rotational element or assembly having a pre-selected magnetic field shape, profile, and radial position in relation to the rotational axis and provides a continuous, operatively radial magnetic work-space comprising at least one continuous and non-sequential magnetic field area in accordance with the pre-selected field profile, radial position, and work-space. The operative radial work-space and permanent magnet rotational element or assembly is supported for rotational motion about an axis perpendicular to the radial work-space and provides a magnetic displacement aspect, referred to as a radial magnetic incline, in accordance with the radial magnetic work-space profile and position relative to the rotational axis. At least one of a permanent magnet reciprocating element or assembly having a pre-selected size and shape provides a magnetic work-space comprising at least one magnetic field area and is supported for reciprocating motion along a plane substantially perpendicular to the rotational axis of a permanent magnet rotational element or assembly and adjacent or within a radial work-space herein described.

A magnetic work-space of either of the elements or assemblies is an area through which the associated magnetic forces operate, or a dimensional air gap, wherein the associated field areas interact and wherein the permanent magnet elements or assemblies do not of themselves physically contact one another in the work-space. Thus, depending on an arrangement or embodiment, a work-space may also include other structures or members, cams or surfaces, bearings or slides, housings, containment vessels, channels, cylinder walls, or the like. When required, working elements in particular embodiments may also be isolated or hermetically sealed there between so as to provide transcutaneous or thru-wall magnetic interaction.

A rotational magnetic work-space and a reciprocating magnetic work-space operatively share work-spaces and also share a common equatorial plane, a plane of magnetic dissection that divides a magnetic field area, divides a single magnetic field, divides at least two combined fields, divides a combination of magnetic axis field orientations, divides operative work-spaces, or is a divisional centerline plane of a magnetic axis. A magnetic field area provided in a rotational work-space and a magnetic field area provided in a reciprocating work-space; however, are not necessarily identical, opposites, or mirror images, or of same size, strength, or shape; are not necessarily congruent, are not required to have the same number of fields, field areas, or orientations; are not required to have the same magnetic axis, are not required to provide a radial magnetic axis even though the operative working force is radial, and are not required to be absent of either one of an attracting or repelling field. Additionally, a rotational magnetic element or assembly does not provide discontinuous, alternating, or sequential fields along the working circumferential path or working perimeter shape of a radial magnetic work-space. Nonetheless, along the shared plane and within the parameters of possible embodiments, the pre-selected profile and magnetic field area of a work-space may be provided by any of the following: a magnetic field area, a single magnetic pole, dipoles, magnetic axis divisional poles, combined fields, multi-pole fields, concentric fields, internal or external fields, cantilevered fields, combined stepped or stacked fields, magnetic assembly fields, separated fields, or combined and spaced fields providing an unobstructed work-space. Repelling, attracting, or a combination of forces may be utilized in a work-space without operational field switching or cogging because fields do not alternate along a perimeter or circumferential path.

Magnetic field sizes, shapes, profiles, and parameters of a rotational element or assembly are selectable and a magnetic field area may assume any of numerous shape configurations including but not limited to the following: circular, pear shapes, heart shapes, eccentric circle, lobed shapes, cam slots, or any other shape. Also selectable is the size, field area shape and profile of a reciprocating element or assembly.

Embodiments that utilize combined fields or the fields of magnetic assemblies in either or both work-spaces can result in significant size verses force potentials and power-weight ratios without saturation or break-down. There are many possible combinations that are capable of handling large displacement forces so that for any given application or requirement, from the least demanding to the most demanding, a proper selection can be made. There are numerous magnetic assemblies and known methods for increasing the forces of magnetic fields and various methods of “piling on” may be utilized without departing from the basic arrangement, relationship, and scope of the inventive concept. For example, it is possible to construct a magnetic assembly in the form of a Hallbach array that is capable of handling very large forces. For intermediate sizes and demands, however, a working prototype utilizing two relatively small, axially-spaced, rotationally off-set permanent magnets, providing an unobstructed radial work-space in conjunction with a single permanent magnet reciprocating element, demonstrated remarkable force and leverage potential in a small package.

Various equations have been established in physics and engineering for the forces of magnetic fields. In applications where exact or average torques and displacements are to be determined along with required tolerances, computational methods or optimization routines can be employed to determine values for magnetic forces within desired parameters and these quantities can be used along with displacement projections or diagrams similar to those generated for friction-based cam systems with designators for trace point, pitch curve, working curve, pitch circle, base circle, stroke or throw, follower displacement, and pressure angle. The nomenclature for a shared magnetic work-space, instead of solely designating physical surfaces however, would delineate a selectable and suitable range of magnetic compression or expansion within an operational work-space, a range of pre-load, or an operational range in relation to an additional mechanical system. Similar, though not equivalent to friction-based mechanical cams, magnetic reciprocating and rotational motion along with torque and displacement can be determined and controlled along time-lines of velocity, acceleration, and dwell within magnetic parameters.

Correlations can be drawn, with regard to profiles and shapes in relation to a rotational axis, between a magnetic work-space of a rotational element or assembly and profiles of mechanical cams and their displacement or leveraging aspect, as with magnetic reciprocating elements or assemblies and followers. This can be done for any profile and for any displacement event. For example, a mechanical triple-lobe cam is a symmetric form that includes the rotational axis whereby the shape and each lobe provides a torque range and displacement or leverage aspect along the radial incline measured from the axis to all points along the shape profile. An eccentric circle cam which includes the rotational axis may be viewed as a single lobe. The leverage or displacement aspect occurs along the radial incline measured from the axis to all points along the shape profile. For an off-set circle cam, the shape does not include the rotational axis whereby the leverage or displacement aspect is also represented by the radial incline measured from the axis to all points along the shape profile.

For purposes of the specification, disclosure, and claims regarding the present invention the terms magnetic leverage aspect, magnetic displacement aspect, magnetic incline, radial magnetic incline, and derivatives thereof are considered interchangeable with conventional terms. A magnetic incline is a distance or operative range of distances that vary, measured from the rotational axis to all points along the magnetic element or assembly profile, or to a range of operational points along magnetic work-space distances. Conventional measurement would represent a hard physical distance while the non-contact, magnetic distance measurements would represent operational distances of magnetic compression or expansion in a work-space.

Analogy with mechanical cam systems is also made to point out that magnetic motion conversion, performed by an embodiment of the present invention, occurs as a result of the continuous shape or profile of a magnetic field area and relation to a rotational axis and not a result of alternating, sequential, or discontinuous fields along a perimeter or shape as shown in the prior art and to clearly show by example that displacement does not rely solely on the strength of the magnetic forces as taught in the prior art. A permanent magnet rotational element or assembly and at least one of a permanent magnet reciprocating element or assembly provide a continuous magnetic field area in the work-space without field switching, cogging, or magnetic force disconnect; wherein one continuously follows or actuates the other in relation to a corresponding rotational or reciprocating motive force, resulting in efficient conversion between rotational and reciprocating motion or a significant reduction of friction in an additionally associated friction-based mechanical system wherein magnetic elements or assemblies do not of themselves contact one another. The interaction of field areas and magnetic forces between working elements or assemblies remain substantially constant except for a natural magnetic compression or expansion in a work-space that may occur under load as one follows or actuates the other. Moreover, it should also be understood that a rotational element or assembly is not necessarily required to undergo continuous rotation, is not required to undergo rotation in only one direction, or to undergo a complete revolution.

Depending on the embodiment, a magnetic work-space may also allow for a variable reciprocating amplitude, bounce space, or dwell within travel distance parameters as magnetic forces compress, expand, or bounce in relation to a work-space. In an embodiment that utilizes two permanent magnet reciprocating elements or assemblies on opposite sides of a magnetic rotational element or assembly wherein the two reciprocating elements or assemblies are connected by a member as in a yoke or similar arrangement, the length of a connecting member can be determined to provide either a magnetic pre-load with a short length or an extended range of reciprocating motion with a longer length connecting member. An amount of bounce-space, pre-load, and reaction time in this manner can be controlled by the connection length. Also, yoke connection length may be adjusted or made adjustable.

In cases where it is desired to provide fail-safe or redundancy measures, or for other reasons discussed, a mechanical contact member, bearing, or mechanical cam may be additionally included to operatively engage at a limit of magnetic compression or expansion in a bounce space or work-space. Also, while magnetic components provide non-contact operation there between, a mechanical device such as a bearing, slide, or other member may have constant contact with a cam or an intermediate surface while the non-contacting components reduce contact load of the additional mechanical members and thus provide a substantial reduction in contact force and wear. Elements or assemblies of the invention may operate to assist, provide return means, or reduce friction or load forces in mechanical contact cam systems as known in the art. In addition, a magnetic work-space or a bounce space may be utilized to reduce hysteresis in a reciprocating actuator element such as a shape memory alloy, may be utilized to avoid problems of “over-shooting”, vibration, or to provide non-jerking or a “soft range” of operation.

Embodiments of the present invention may be grouped, clustered, or combined in numerous ways. Multiple devices may be grouped along a common shaft, for example, or a rotational magnetic element may be shared by multiple reciprocating elements positioned in a radial array. Also, two separate permanent magnet rotational elements or assemblies may share a common reciprocating element or assembly. Two separate permanent magnet rotational elements or assemblies may share a common reciprocating element or assembly along a common plane and in-line or peripherally as in the construction of a non-contact rhombic drive. More than one element or assembly may share a common rotational axis and a common equatorial plane, may be formed as a cam slot, or more than one cam slot, in plane with each out of phase. Various return means, structures, methods, or systems for a reciprocating element return position may be provided, including but not limited to the following: an optional embodiment wherein particular parameters unique to the arrangement provide return means without additional components, a mechanical means or member, flywheels, mechanical or magnetic springs, an additional magnetic assembly, a magnetic or mechanical yoke arrangement, electro-magnetic coils, pressure differentials, gravitational forces, attachment to a prime mover or motive force, and the use of combined units. It should also be understood with regard to the numerous possible embodiments of the invention that various rotational, reciprocating, and linear bearing means may be provided such as low friction coatings, ceramic bearings, gas bearings, fluid bearings, or magnetic bearings, along with foil bearing systems, v-groove bearings, slide tables, and pivot bearings, among others. A linear bearing means may also be incorporated and provided by the structure or device of an associated system; for example, an extended “H” pattern yoke member having the tip ends connected to four pistons that slide within cylinders may also serve as linear bearing means. A mechanical version of such is shown in Japanese Patent, JP2004293387; (2004) to Kamiyama Eiichi. Also, similar to a Bourke-type engine, a bi-directional piston engine is shown in U.S. Pat. No. 5,873,339 (1999); to Isogai.

Elements, components, assemblies, or individual units with regard to embodiments may be produced or manufactured as modular or removable and may be in kit form. Embodiments may be utilized in a broad range of applications including numerous types of motors, pumps, valves, generators, vibrational devices, sensors, and material handlers, as well as Stirling engines, acoustic engines, and other devices having pistons, piezo elements, electro-magnetic coils, expandable membranes, shape memory alloys, and the like, where such devices require efficiency or significant reductions in frictional loss, require non-contact between working components, or require isolation of components.

In view of the prior art, the numerous unsolved problems and requirements for emerging technologies, there is a need for a device and method in the field of motion conversion that meets the challenges and represents a viable alternative and solution to the problems of mechanical systems. Embodiments of the present invention represent an enabling technology that overcomes problems of the prior art and provides an efficient, direct, and robust solution at any scale. It is therefore an object of the present invention and the various possible embodiments to replace friction-based mechanical devices that convert rotational and reciprocating motion, to eliminate major problems in mechanical systems due to friction and wear, and to provide design engineers with a new tool box of efficient magnetic cams and motion conversion devices.

The disclosure of the invention herein also relates to co-pending application 60/039,601.

### BRIEF DESCRIPTION OF THE SEVERAL VIEWS OF THE DRAWINGS

The above mentioned features of the invention will become more clearly understood from the following detailed description of the invention and embodiments read together with the drawings in which:

FIG. 1 is an explanatory top plan view of permanent magnet rotational element of an embodiment of the invention.

FIG. 2 is an explanatory side plan view of FIG. 1 with example of at least one of a permanent magnet reciprocating element and the equatorial plane.

FIG. 3 is an explanatory side plan view of an alternate embodiment of the invention.

FIG. 4 is a top plan view of an alternate rotational element and embodiment of the invention.

FIG. 5 is a side plan view of FIG. 4 and further explanatory view of the equatorial plane.

FIG. 6 is a side plan view of an alternate embodiment of the invention.

FIG. 7 is a side plan view of another embodiment of the invention.

FIG. 8 is a side plan view of another embodiment of the invention with means for isolating components.

FIG. 9 is a side plan view and explanatory view of an alternate embodiment of the invention.

FIG. 10 and FIG. 11 is a top and side plan view of another embodiment utilizing a connecting yoke member.

FIG. 12 is a top plan view of an embodiment showing a connecting yoke along with means for isolating components.

FIG. 13 A and FIG. 13 B is a top and side plan view of an alternate embodiment of the invention.

FIG. 14 is a top view of FIGS. 13 A and 13 B.

FIG. 15 is a top plan view of another embodiment of the invention.

FIG. 16 is a side plan view of alternate embodiments of the invention combined along a common shaft.

FIG. 17 and FIG. 18 is a top and side plan view of another embodiment of the invention.

FIG. 19 is a side view of prior art in contrast to the present invention.

### DETAILED DESCRIPTION OF THE SEVERAL DRAWINGS

While viewing the illustrations and explanatory drawings, it should be understood that particular supporting structures, substrates, or members for connecting magnets or assemblies in many examples are not shown that would nonetheless be practically applied on the basis of known machining practices and loads or stresses for a given or chosen application and that a selectable shape of the working magnetic field areas and components may be independent of bonding structure shapes and peripheral or additional structures that may be provided separately or integrally with components of the invention. Further, numerous bonding methods or magnetic assemblies may be utilized and there are numerous companies who specialize in the production of custom magnetic assemblies. It should further be understood that sizes, shapes, profiles, and spacings are shown for purposes of illustration and may vary substantially. It should also be understood that the invention may take various forms and that there are numerous possible embodiments of the invention, but for the sake of brevity only the most basic are shown and highlighted to clearly show structure, arrangement, continuous magnetic relationships, and basic operations along a common work-space and equatorial plane.

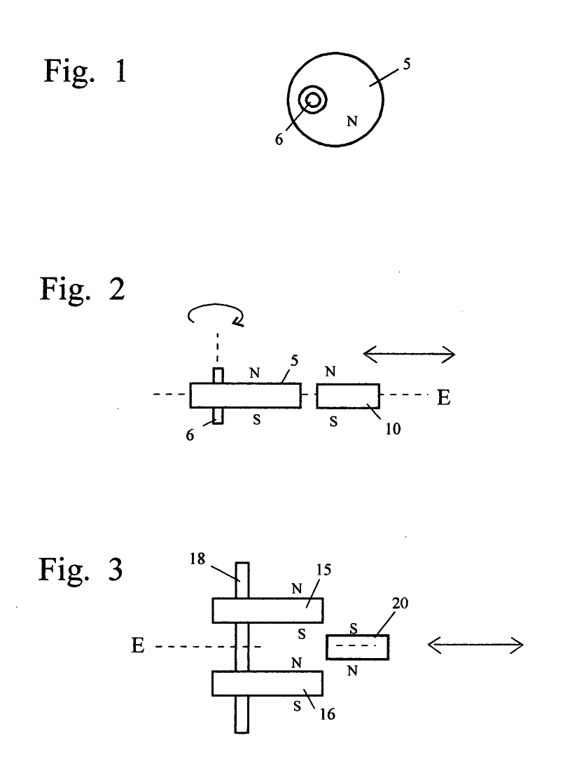

In the explanatory top plan view of FIG. 1, one embodiment and example of a permanent magnet rotational element 5 of the present invention is shown having a shaft and rotational axis 6 with the axis included and encompassed by the rotational element shape. In this example the selectable magnetic shape is an eccentric circle or disc and can be manufactured with an off-set bore for accommodating a shaft 6. The rotational element 5 as further shown in the explanatory side plan view of FIG. 2, has a north and south pole magnetic axis arranged parallel with the axis of rotation and provides a combined field radial work-space in the air gap; in other words, the operative area of the magnetic circuit or flux linkage of the rotational element 5 is along the equatorial magnetic plane and about the radial perimeter magnetic work-space. The field is continuous and unchanging around the entire field shape of the rotational element and along the equatorial magnetic or divisional plane E. The operatively radial work-space of the rotational element rotates about an axis perpendicular to the radial work-space. A continuous repelling force in this example is provided in the air gap or work-space of the rotational element 5 along the perimeter in relation to at least one of a second reciprocating permanent magnet element 10, having an identical magnetic axis in this example as the rotational element. The reciprocating element 10, reciprocates adjacently and in line with the equatorial plane E and along the operatively radial work-space. Of course a shaft in this explanatory example would also be supported for rotation with bearings and a base and a reciprocating component would be supported for that motion. The repelling magnetic fields are compressed in the radial work-space under load between the rotational element and the reciprocating element at an operational work-space distance in relation to a suitable load within the operational range of non-contacting elements as one magnetic field follows or actuates the other by non-contact leveraging displacement there between in relation to the off-set or eccentric rotational axis. It can be understood in this explanatory example that an air gap dimension between the permanent magnet rotational element 5 and the permanent magnet reciprocating element 10 is not required to change beyond the normal parameters of field compression for a given load. It can also be understood in this example that the magnetic fields of both elements are not required to change polarity, switch, cross-over, pass-by, or disconnect the magnetic force along the travel path as one continuously actuates or follows the other throughout a complete cycle. Magnetic orientations in this example could also be changed to provide a force of attraction between the components. In that case a mechanical follower or roller (not shown) would be additionally attached and provided to maintain the non-contact magnetic spacing while contacting either the profile of the magnetic rotational profile or an additional cam surface along the axial surface area of the component 5. That particular arrangement would also provide return means for a follower.

The shape, profile, size and surface area, in accordance with a magnetic element or assembly, magnetic field strength, and displacement distance would be preselected in relation to the desired limit of field compression or expansion in a work-space under required load parameters while also considering the inherent leveraging aspect of the design. With regard to profiling a magnetic element or assembly, and by example, the facing edge surface areas of rotational element 5 and reciprocating element 10 may be contoured or curved in profile so that one matches the other in a “male” and “female” correspondence. This example, along with other that follow, can provide substantial non-contact forces between the working components.

With the advent of “super” permanent magnets in recent years, such as neodymium and samarium cobalt, even a small size permanent magnet produces a large force per size and weight. In addition to this, a proper magnetic assembly or arrangement of combined magnetic fields in various embodiments can increase or more than double forces in a work-space. In most cases and at any scale more than adequate power-weight ratios may be obtained.

An embodiment and example of combining fields and yielding larger forces is shown now in the explanatory side plan view of FIG. 3. In this drawing two axially spaced permanent magnet rotational elements 15 and 16, both similar to element 5 of FIG. 1, are mounted congruently along a shaft 18 at a preselected spacing distance along the shaft. Field lines of the south polar face of 15 and the north polar face of 16 are axially combined by attraction and merge through a normal midpoint and divisional equatorial magnetic plane E, while providing an operatively radial magnetic work-space along the perimeter. Reciprocating permanent magnet element 20, in this example sized more narrowly than the axial space provided, is polarized with like repelling field alignment so that a repelling force increases as the reciprocating element attempts to move into the now unobstructed work-space and where the forces resist radial insertion into the space at a radially operative distance determined by a range of load. By proper selection of magnets, size, and spacing in relation to the load applied, the reciprocating magnetic element 20 will not be allowed to fully enter the radially operative work-space and will stop at an operational radial work-space distance from the axis of the rotational elements while leveraging the rotational element field along the eccentric axis and continuous radial work-space herein defined. Although unnecessary in most cases, a fail-safe contact surface can be provided as a cam surface smaller in diameter than the elements 15 and 16 to occupy the work-space there between with a surface area of “touch-down” existing at a selected travel distance limit of field compression. A laminate or material can be bonded to the facing surface of a reciprocating element to protect the magnet material or another type of bearing may be integrally provided.

The magnetic forces in this example combine and interact in several unique ways. Not only do the north and south fields of the reciprocating element 20 repel the corresponding like poles between the rotational elements 15 and 16 with a radial force, but the established field lines of attraction force between elements 15 and 16 resists any change to their natural alignment with a resistive radial force. In addition, other forces are occurring that are unique to this arrangement. Still viewing FIG. 3, the upper north field of 15 and the lower south field of 16 attract the upper south field and lower north field of reciprocating element 20 respectively. Within certain parameters this additional force will sufficiently hold the reciprocating magnet (when supported for reciprocating motion) approximately at the relative air gap distance as shown in the drawing while allowing rotation and reciprocation of the elements. Not only is insertion into the work-space resisted by repelling forces but a force of attraction resists both insertion and removal or pulling away of the element to an increased air gap distance. Given this anomaly, a return means for the reciprocating element in particular applications would not be necessary since it is provided by the very arrangement of the elements and proximity of the fields. In the specific example this only occurs, however, under particular conditions that are dependent on the axial spacing distance of the rotational elements along with the dimensions of the reciprocating magnet within close tolerances. There are also other magnetic assemblies or combined fields that may provide that same result and will be later discussed. Aside from that aspect, however unique and useful it may be for some applications, the example and arrangement of combining fields as shown in the drawing, even without close tolerances, provides a very strong radial, repelling field without saturation or breakdown and a remarkable volume to force ratio and torque potential within a substantially unobstructed work-space having a greater potential operating range. The width of a reciprocating magnet in this regard is also a determining factor. To better understand the relationship, imagine a locked rotor condition and the reciprocating magnet being pushed into the work-space to a position beyond an acceptable operating range. As long as there is sufficient width of the reciprocating magnet the repelling forces will substantially increase until most of the width is forcefully inserted beyond the operational limit. At this transitional point the radial repelling force would change over to an axial repelling force and repel the reciprocating magnet in the axial direction. This would represent a position of balanced forces or overload for the operational range. Thus, in applications where this condition might occur it becomes advantageous to also include a “touch-down” bearing or similar member. As mentioned, however, in most cases this would not be necessary as the repelling radial forces can be considerably strong.

An alternate magnetic arrangement, not shown but somewhat similar to FIG. 3 and utilizing combined fields of two axially spaced magnetic rotational elements, would be to orient the fields of element 15 and 16 so that a combination of like poles, for instance two north poles repelling each other, provide a combination of additive repelling forces along the operatively radial work-space. In that case, instead of the reciprocating element 20 having a magnetic axis parallel with the rotational axis, a north pole face would be oriented to face the net radial field work-space having combined repelling north fields along the equatorial plane. In that example the magnetic axis orientations of the reciprocating element and the rotational elements would not be parallel and by performing an element by element weight and size comparison the radial repelling force shows lesser forces than the previous example, however the option is provided for applications where that particular arrangement has other advantages. There are various other combinations and field orientations that may be utilized and examples will be discussed further on.

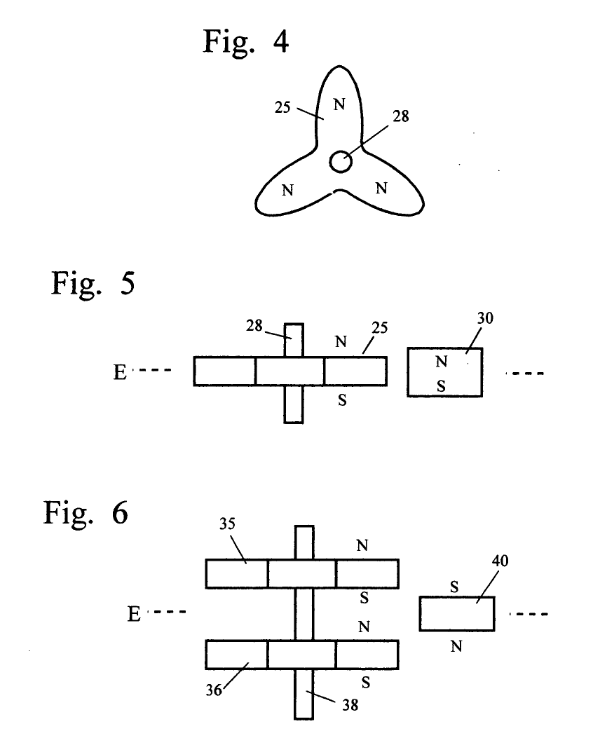

Continuing in the discussion of embodiments wherein a permanent magnet rotational element or assembly has a selectable shape and profile with a continuous, operatively radial work-space, another example is shown in the explanatory top plan view of FIG. 4. Instead of an eccentric circle cam, the rotational magnetic element shape 25 in this figure is a lobed cam profile having three lobes wherein the selectable shape or work-space encompasses and includes the rotational axis shaft 28. The magnetic axis of the rotational element 25, as shown in the explanatory side view of FIG. 5, is parallel with the rotational axis shaft 28 and provides an operatively radial work-space along the equatorial plane E with radial magnetic incline areas along the equatorial plane and work-space perimeter. A reciprocating permanent magnet element 30 reciprocates adjacently with like poles and like magnetic axis providing a constant repelling force in the radial air gap that continuously follows the shape of the rotational element field. Again, as in all cases of the invention, magnetic fields of the working elements are not required to change polarity, switch, cross-over, pass-by, or disconnect the magnetic field alignment or force there between as one follows or actuates the other. With regard to the leveraging aspect of the invention and for additional clarification a radial magnetic incline is provided by the operative field of the rotational element in accordance with the shape and rotational axis position. The incline area can be measured from points along the rotational magnetic work-space to the rotational axis in relation to the rotational angle and the working field of the reciprocating element.

The explanatory side plan view of FIG. 6 shows two axially spaced permanent magnet rotational elements 35 and 36 that are the same shape as shown for the element 25 in FIGS. 4 and 5. The same relationship is provided as previously discussed for FIG. 3, such that combined fields are provided in the unobstructed radial work-space along the equatorial plane E. In this example a reciprocating permanent magnet element 40, reciprocates adjacently or at a distance of field compression within the work-space; and for a triple magnetic lobe shape, the reciprocating element would reciprocate three complete cycles for each revolution of the shaft.

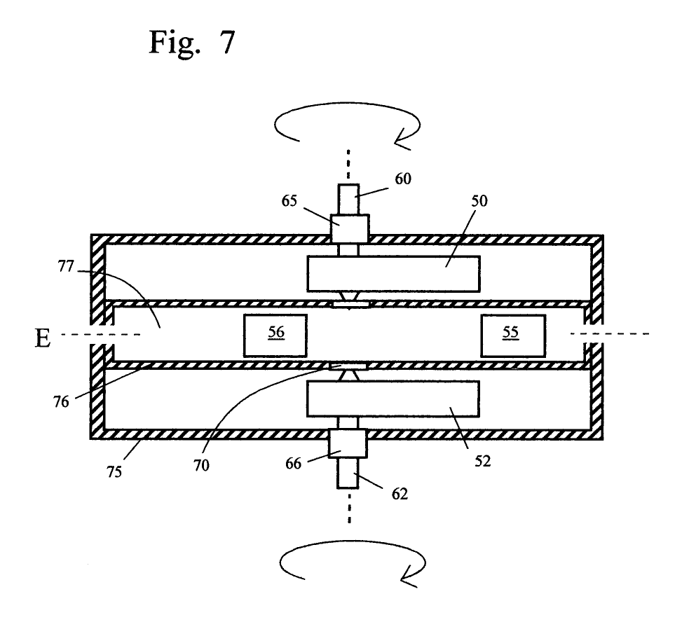

In the examples as shown and discussed in FIGS. 3 and 6, two axially spaced permanent magnet rotational elements are aligned congruently along a common shaft and rotational axis and provide a substantially unobstructed work-space; however, in some cases two axially spaced rotational elements providing combined fields in the work-space need only share a common rotational axis without being connected to the same shaft and without a shaft continuing through the space provided between the rotational elements, as shown now in the explanatory side plan view of FIG. 7.

In this embodiment two axially spaced rotational elements 50 and 52, eccentric circles in this example, are supported for rotational motion by separate shafts 60 and 62 respectively with bearings 65 and 66 fixed to a housing 75. Pin or thrust bearings 70 also support the separate shafts and are fixed to channel members 76. Permanent magnet rotational elements 50 and 52 are magnetically oriented to attract each other and maintain congruent alignment by the attraction force through the space between them while also providing the operatively radial work-space for two permanent magnet reciprocating elements 55 and 56 along the magnetic equatorial plane E. The work-space and the space between the rotational elements in this example is completely unobstructed and provides by this arrangement various application and construction options. For instance, if it is desired to connect the reciprocating elements 55 and 56, a connecting member can occupy the lateral space between them without having to provide a slot in the member for accommodating a shaft that would otherwise be an obstruction through the center axis. This of course is only an option. A shaft can extend through the center space and reciprocating elements can be connected by a member having a slot to accommodate the shaft. Another method for connecting the reciprocating magnets is the constructing of channel members 76 as vessels or cylinders that surround the reciprocating magnets so that the magnets serve as pistons having a sealing and sliding means such as encapsulation by a magnetic fluid so that a formed and sealed cavity would exist in the space between them. The cavity may contain a compressible or non-compressible gas or fluid, or may simply provide an atmospheric vapor lock. In any case the construction would provide return means for the two reciprocating elements by way of pressure differentials there between as each is caused to move in tandem with the other as if they were physically connected. The cavity spaces at the outer ends of the reciprocating magnets may also utilize pressure differentials as an actuation means or motive force for the reciprocating elements or in reverse operation for pumping applications or may also be utilized as return means. Additional examples of this will be discussed below; and of course the reciprocating magnets may be connected to a member or push rod in conjunction with a prime mover or output, or they may be actuated by some other means or device as previously discussed.

At this point, while still viewing FIG. 7, it should be clear and understandable that by constructing cylinders or vessels, whether shaped to the contour of the reciprocating magnets or not, the working elements of some embodiments may be separately contained and hermetically sealed there between and that the operation of the working elements may convert motion transcutaneously or thru-wall, assuming that the containment vessels are constructed of a material that does not adversely affect the operating magnetic fields. There are other methods and constructions available to the present invention for sealing or hermetically isolating the working elements and further examples will be shown.

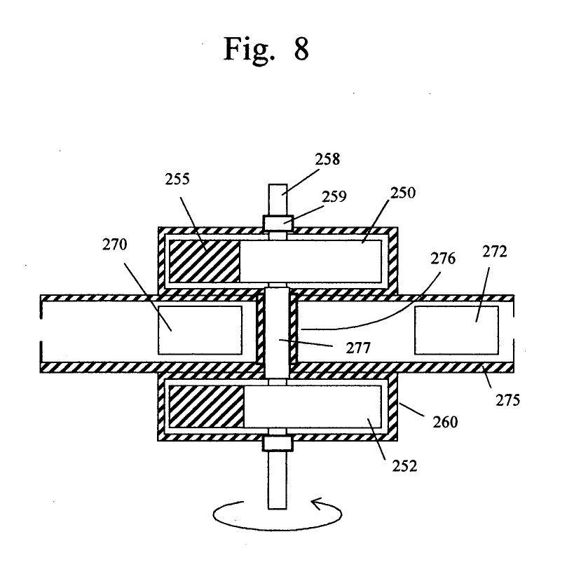

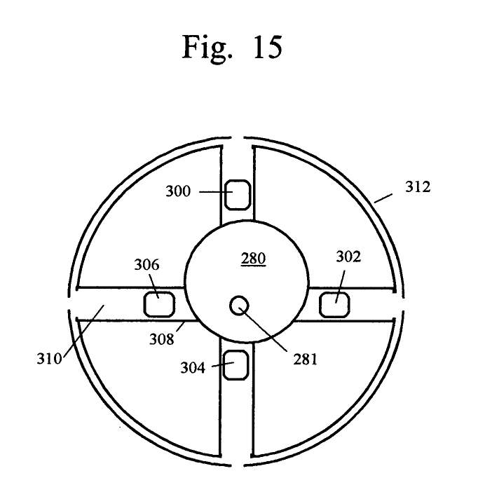

Viewing now the explanatory side plan view of FIG. 8, an alternate embodiment and method for isolating the working elements is shown. Two axially spaced permanent magnet rotational elements 250 and 252, in this example having counter-balance weights 255 for the off-set, are attached to a shaft 258 that rotates through bearings 259 mounted to a housing or base 260. The shaft extends through the axial spacing and through a containment isolation sleeve 277. Permanent magnet reciprocating elements 270 and 272, reciprocate within containment housings 275 that effectively isolate the working elements. Although not shown in this drawing but more suitably shown in FIG. 15 that follows, the reciprocating magnets 270 and 272 may also be provided with a connecting member between them such as a yoke or slotted member that would surround the containment sleeve 277 while being properly accommodated for by an appropriate construction of the housing 275. This particular method and construction would allow a shaft to pass through the rotational element spacing while also isolating working elements.

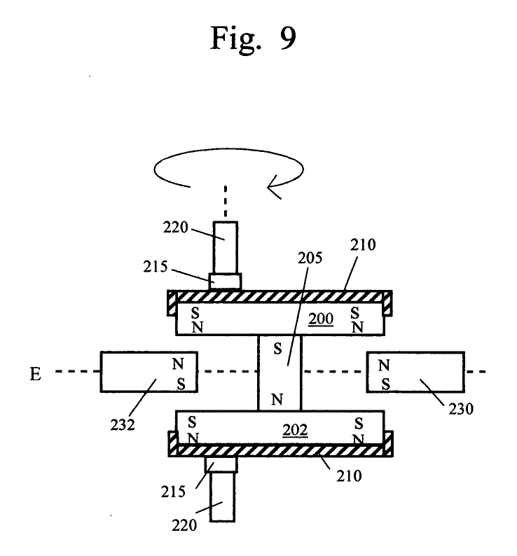

The explanatory side plan view of FIG. 9 shows an embodiment and example wherein the shaft does not directly extend through the axial space of the two permanent magnet rotational elements but wherein the elements are nonetheless physically connected. This construction is similar to a cam shaft. Two eccentric circle, axially spaced permanent magnet elements 200 and 202 are fixed to shafts 220 supported for rotation through bearings 215. The two elements are also connected there between by a rod, or in this example a rod or cylindrical magnet 205. The magnetic equatorial plane E is a divisional plane through the center of the rotational elements, through the center of the work-space, and divisional through the connecting magnet 205 that is centered in the axial space of the rotational elements and off-set from the rotational axis. Similar, as previously described, permanent magnet reciprocating elements 232 and 230 would be supported for reciprocating motion along the shared equatorial plane. Also in this example are mounting members 210 that are fixed to the two rotational elements. These mounting members may be provided for better connection between the shaft and the rotational elements, provide rigidity, and may be constructed from various materials such as steel, brass, or plastic. Also, although the connecting magnet 205 is shown having a particular polar orientation, the poles may be oriented oppositely as also the magnetic axis may be variously oriented or an alternate shape or magnetic assembly may be utilized with similar results as described throughout the specification. One method of construction for this example would be to use ring or donut magnets with a center bore for the two axially spaced magnets 200 and 202 so that a rod or magnet 205 would fit and be bonded inside the bore holes. Of course the same could be done for the shaft 220 if desired. Also, a mechanical “touch-down” bearing can surround the rod 205 with an appropriate diameter and facing areas of the reciprocating elements can be provided with a low friction laminate or some other construction as previously discussed.

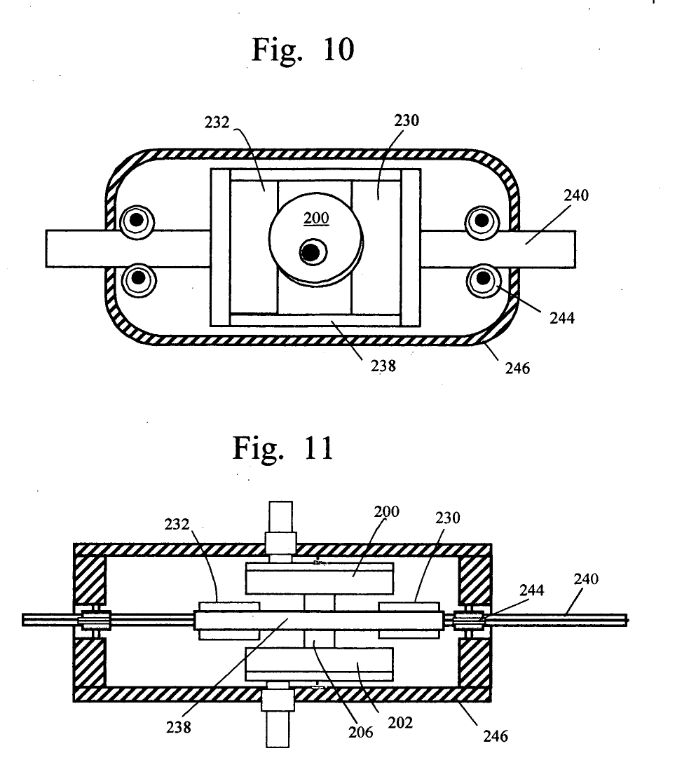

In the case of utilizing two permanent magnet reciprocating elements as shown in FIG. 9, the reciprocating elements are not required to have connection there between and may be supported to reciprocate independently; however, the two elements may be connected in a yoke arrangement as shown by example now in FIGS. 10 and 11.

In the top plan view of FIG. 10 and side plan view of FIG. 11, two rectangular bar shaped reciprocating magnets 230 and 232 are connected to a common yoke member 238 that is further connected to a guide member 240 in the form of a v-groove rail that is supported for linear reciprocating motion by v-groove bearings 244 mounted to a base and housing 246. Similar to FIG. 9, two axially spaced permanent magnet rotational elements 200 and 202 have mutual connection through a rod member 206. In this example the reciprocating bar shaped magnets having connection by the yoke member are pre-loaded against the repelling force in the substantially unobstructed work-space at a distance determined by the length of the yoke. The connecting member length, as previously discussed, can be adjusted or be made adjustable for various reasons. As shown in FIGS. 10 and 11, pre-load positions the inside edges of the reciprocating magnets inwardly beyond the perimeter edges of the axially spaced rotational elements so that the repelling magnetic fields are compressed at a selectable pre-load operational work-space position. This embodiment and design is similar in appearance to a mechanical scotch-yoke mechanism but without contact between working surfaces, thus eliminating major frictional failing points and eliminating motion conversion slides and bearings that would otherwise require lubrication. The support means for reciprocating motion shown in this example as v-groove bearings may be provided by numerous other constructions, configurations, or bearing systems.

As previously discussed, the length of the yoke connection in this example for pre-loading may also be extended in length for a different consideration. An increased bounce space can be established to provide a delayed response or dwell. In addition, although the inside edges of the reciprocating bar magnets are shown as a straight edge, the edges may be contoured or curved to provide dwell or the edges may slanted in plane for this or other reasons.

As also previously mentioned, when an application or requirement calls for redundancy or fail-safe considerations, as in cases for instance where a partially locked rotor could occur due to an external system failure or in cases where a “touch-down” is desired for a particular application or operation, a mechanical slide or bearing may be additionally provided. In the example shown in FIG. 11, a mechanical bearing could be included and mounted on the connecting rod 206 that would touch-down against an appropriate edge surface applied to the inner edges of the reciprocating magnets 230 and 232. Or, in cases where a connecting member between the axially spaced magnets is not provided and the space is completely unobstructed as in the example of FIG. 7, an overload or locked rotor could simply allow a runaway condition between the fields until a system is shut off. Of course some type of travel limits would likely be required for the reciprocating excursions in that particular arrangement. Again, “touch-down” or continuously contacting mechanical components or cams may be provided as integral or separate assemblies. Elements or assemblies of the invention may operate to assist, provide return means, or reduce friction or load forces in mechanical contact cam systems as known in the art.

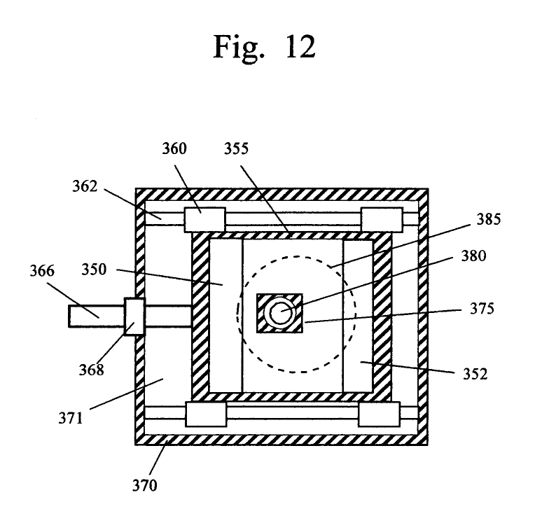

Another embodiment and method for isolating the working elements wherein a yoke member connects two reciprocating elements, is shown in the top plan view of FIG. 12. In this embodiment two axially spaced permanent magnet rotational elements are utilized as previously shown in FIG. 3 and FIG. 8, and in this drawing is generally shown by dotted line 385 for ease of viewing the other components to be discussed. The rotational shaft 380 connects the spaced rotational elements and extends straight through the spacing and isolation sleeve 375 that is similar to the isolation sleeve 277 of FIG. 8. Bar-shaped permanent magnet reciprocating elements 350 and 352 are fixed to a connecting yoke member 355. A linear bearing means is provided in this example by sleeve bearings 360 fixed to the yoke member that slides along guide rods 362 and an input or output rod 366 is also connected to the yoke member and slides through a sleeve bearing 368. The guide rods and the output sleeve bearing are fixed to a containment housing 370 that is also sealed and bonded with the center isolation sleeve 375. In this manner, similar to the arrangement shown in FIG. 8, the working elements may be isolated or hermetically sealed there between.

It should be understood in this and other embodiments of the invention that various rotational, reciprocating, and linear bearing means may be provided such as low friction coatings, ceramic bearings, gas bearings, fluid bearings, or magnetic bearings, along with foil bearing systems, v-groove bearings and pivot bearings, among others.

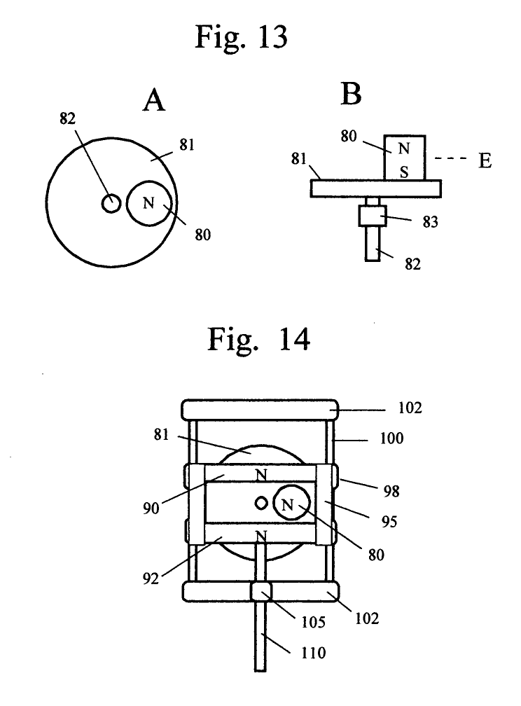

Another embodiment of the invention is shown now in the top plan view of FIG. 13 A, the side explanatory view of FIG. 13 B, and the top plan view of FIG. 14. In this embodiment a permanent magnet rotational element 80 has a magnetic axis parallel with the rotational shaft 82 and has intermediate connection to the shaft by a disc member 81. Of course another shaft and disc connection could be provided on the other end of element 80 or as similarly shown in FIG. 9. Still viewing FIGS. 13 and 14, the permanent magnet rotational element 80 and associated field is off-set from the rotational axis and does not encompass the axis, nonetheless the radial incline and leveraging aspect is measured from all points along the perimeter shape and field in relation to the rotational axis. The permanent magnet rotational element rotates along the equatorial plane E, perpendicular to the rotational axis. The shaft 82 is supported for rotation by a bearing 83 that would be further supported by a base (not shown) and connects the disc member 81. Viewing FIG. 14, two permanent magnet reciprocating elements in this example 90 and 92 are connected by a yoke member 95 that is further connected to sleeve bearings 98 that slide on guide rods 100. The guide rods are fixed to base members 102. An input or output connecting rod 110 is also connected to the yoke member and slides through bearing 105. Again in this example, two permanent magnet reciprocating elements along with the yoke connection form an elongated magnetic aperture and capture the permanent magnet rotational element for mutual operation and return. It is also possible in this and other examples that the yoke members 95 are also permanent magnets in plane and with a magnetic axis identical to magnets 90 and 92, or they may be oriented oppositely and axially space. It may also be constructed so that the reciprocating magnets and yoke assembly are a one piece, formed permanent magnet having an elongated aperture as integral to the shape and with curvatures to eliminate the square corners. In general, sizing parameters for the particular embodiment shown in FIG. 14 would provide a reciprocating element or assembly having a length along the equatorial plane at least twice as long as the distance measured from the rotational axis to the center point of a rotational magnetic element. However, a more suitable length for this embodiment would be a reciprocating element or assembly having a length at least twice as long as the greatest distance measured from the rotational axis to the radial magnetic incline measured at all points along the rotational magnetic element or assembly which in this case is also a greatest measure of distance to all points along the perimeter of a rotational magnetic element or assembly shape.

Another embodiment of the invention is shown now in the top plan view of FIG. 15, also similar in construction to the embodiment shown in FIG. 7 or FIG. 8, wherein a rotational shaft 281 may or may not be required to extend through a space provided by two axially spaced permanent magnet rotational elements, a top element of which is shown in this drawing as 280. Similar isolation and hermetic sealing methods can be utilized in this example as previously discussed. Multiple permanent magnet reciprocating elements 300, 302, 304, and 306 are provided and are isolated by containment vessels or cylinders 308. Interconnection of the vessels through channels 310 on either sides of the elements may also provide return means and mutual actuation of the reciprocating elements by way of pressure differentials there between and internally or externally through the channels. When reciprocating elements perform as pistons, are connected to pistons, or are constructed to seal and slide within channels, the channel spaces can mutually provide return means or actuation means by a pressure differential force within the channels. The channels may be filled with a compressible or non-compressible fluid or gas, or in some cases may be filled entirely with a magnetic fluid. It is also possible to variously connect channels, for example in series, parallel, or alternating pairs. Of course push rods may also be connected to reciprocating magnets that would extend out of the housing 312. Additionally, a connecting member can be provided between elements 300 and 304 along with a connecting member provided between elements 302 and 306. Such connecting members would have a slot to accommodate the shaft 281 while being axially off-set from each other for the crossing.

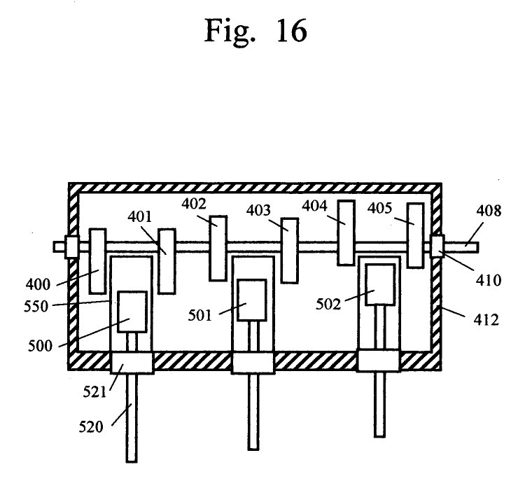

The side plan view of FIG. 16 shows an embodiment wherein multiple units of the invention are combined to share a common rotational axis or shaft 408, supported for rotation by bearings 410 fixed to a containment housing or base 412. Pairs of axially spaced permanent magnet rotational elements 400 and 401, 402 and 403, and 404 and 405, are arranged and fixed along the common shaft in phase shift relation thereto and magnetically interact with permanent magnet reciprocating elements 500, 501, and 502 respectively. The reciprocating elements are also connected to input or output rods 520 that slide through bearings 521 also fixed to the containment housing. In this example, the reciprocating elements are also isolated from the rotational elements by containment vessels or cylinders 550 so that intermixing of gases or fluids is avoided. The containment vessels or cylinders 550 may also be interconnected through channels for usage of pressure differentials there between as previously shown and described by example and may be interconnected in an alpha, beta, or gamma-type configuration as known and commonly used in Stirling engine constructions. In this regard, push rods 520 may be further connected to pistons, displacers, or a combination of both; or the push rods may be eliminated when the reciprocating magnets are used as pistons or displacers or are constructed as integral to pistons or displacers. Moreover, each work-space section of axially spaced rotational elements may include two or more permanent magnet reciprocating elements and may be constructed in radial arrays and along a common rotational axis in similar fashion as shown in FIG. 10 and FIG. 15 or any other possible combination of units.

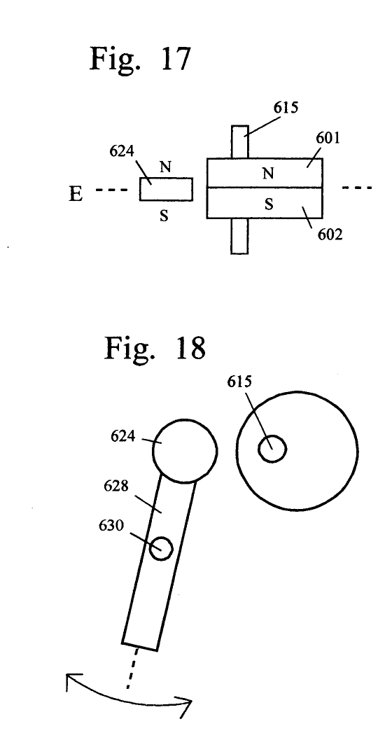

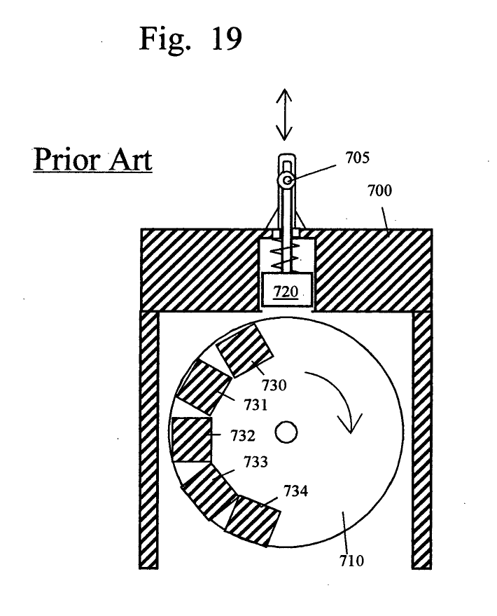

Although most embodiments of the invention have shown permanent magnet reciprocating elements supported for reciprocating motion along a substantially linear path. A reciprocating element may also be supported for reciprocating motion by way of a lever or pivot construction wherein the reciprocating element reciprocates along the equatorial plane and in the magnetic work-space as shown in the side explanatory view of FIG. 17 along with the top plan view of FIG. 18. Also, an alternate magnetic assembly is shown. In FIGS. 17 and 18, it can be seen that a permanent magnet assembly and rotational element is provided by two eccentric discs or eccentric cylindrical band magnets 601 and 602 fixed to a shaft 615. Each band is radially polarized and their combined fields are utilized along the equatorial plane E. A permanent magnet reciprocating element 624 has a magnetic axis that is coaxial with the shaft, with north and south fields also aligned along the equatorial plane to provide a repelling force in the work-space. It can be seen in this example that the radial magnetic force is not required to be provided by similar or identical magnetic axis orientations between working components. Viewing FIG. 18, the reciprocating magnet element is attached to a lever arm 628 that pivots on a shaft axis 630 and reciprocates along the common plane and work-space as described. This type of reciprocating support arrangement may also be utilized in any other embodiments as shown or described.

While there has been described and illustrated herein various embodiments of the invention, it is not intended that the invention be limited thereto. Thus, while various magnetic assemblies and arrangements have been shown there are also other orientations and assemblies that may be incorporated without departing from the general inventive concept of a continuous radially operative field between two motion conversion magnetic elements or assemblies without field cross-over or cogging. For example, two axially spaced permanent magnet rotational elements may each be constructed of a magnetic assembly such as concentric rings or other shapes. Concentric rings or shapes may be stacked or cantilevered and a field of attraction may be utilized to maintain a reciprocating element at a desired radial work-space distance. Forces of attraction may be utilized instead of repelling forces or combinations may be utilized. Further, a permanent magnet reciprocating element may be constructed of a magnetic assembly or may be constructed with two axially spaced elements that would also allow a substantially unobstructed work-space. Further, a permanent magnet rotational element may be constructed in the form of a contoured external cam with the reciprocating element cantilevered and located interior to the cam. Such may also be constructed in conjunction with an interior magnetic cam to form a non-contact rotational cam slot.

Drawings and descriptions, along with defining aspects have been provided showing basic arrangements, operation, and embodiments of the invention and various possible alternatives while showing contrast with the prior art. Accordingly, departures may be made from such details without departing from the spirit or scope of applicants general inventive concept.

Having thus described the aforementioned invention, I claim:

1. A magnetic cam device comprising:
at least one permanent magnet rotational element provides a magnetic field shape and forms a continuous radial magnetic work-space having a magnetic incline in accordance with said element shape;
said continuous radial work-space and permanent magnet rotational element is supported for rotation about an axis perpendicular to said work-space; wherein said element and work-space encompasses and surrounds the axial line of the rotational axis; and wherein further said work-space has a continuous path of non-changing field orientation along the work-space perimeter and the equatorial plane of said radial work-space;
at least one second permanent magnet element having a shape and profile provides a magnetic field area and is supported for reciprocating motion; wherein said element reciprocates in conjunction with the work-space and along the equatorial plane of said radial magnetic work-space;
the at least one magnetic rotational element and the at least one reciprocating magnetic element provides a constant magnetic force there between without field cross-over, pass-by, or disconnect, and without contact of said elements; wherein one continuously follows or actuates the other in response to a motive force.

2. The device of claim 1 wherein:
at least two reciprocating permanent magnet elements are circumferentially spaced for mutual and cooperating magnetic action.

3. The device of claim 2 wherein:
said at least two reciprocating permanent magnet elements are connected by a member there between.

4. The device of claim 2 wherein:
the at least two reciprocating magnetic elements are each contained to reciprocate within a containment structure that accommodates the shape of said elements.

5. The device of claim 4 wherein:
said containment structures have interconnection routes there between for transfer of pressure differentials between said containment structures and between the at least two reciprocating magnetic elements; wherein further a low-friction slide and sealing means is provided between the outer surface of the magnetic element and the inner surface of said containment structure.

6. The device of claim 1 wherein:
said radial work-space of said at least one magnetic rotational element is provided by a magnetic assembly having combined fields.

7. The device of claim 6 wherein:
said combined fields are constructed by at least two axially spaced magnets that provide a substantially unobstructed radial work-space along said equatorial plane.

8. The device of claim 1 wherein:
the magnetic field of the at least one reciprocating element is provided by a magnetic assembly having combined fields.

9. The device of claim 8 wherein:
said combined fields are constructed by at least two spaced apart magnets that provide a substantially unobstructed work-space along said equatorial plane.

10. The device of claim 1 wherein:
said magnetic field shape of said rotational element is an eccentric circle.

11. The device of claim 1 wherein:
said magnetic field shape of said rotational element is in the form of a lobed cam having a number and shape of lobes.

12. The device of claim 1 wherein:
at least two of said devices are combined or grouped for mutual and cooperating magnetic action.

13. The device of claim 1 wherein:
said device is constructed in conjunction with a friction-based mechanical cam for assistive operation there between.

14. A magnetic cam device comprising:
at least one permanent magnet rotational element having a shape and profile provides a magnetic field area that forms a continuous radial magnetic work-space;
said radial work-space of said at least one permanent magnet rotational element is supported for rotation about an axis perpendicular to said work-space; wherein said rotational element field is off-set and wherein said element does not surround the axial line of the rotational axis; and wherein further said work-space has a continuous path of non-changing field orientation along the work-space perimeter and the equatorial plane of said radial work-space;
at least one of a second permanent magnet element having a shape and profile provides a magnetic field area and is supported for reciprocating motion; wherein said element reciprocates in conjunction with the work-space and along the equatorial plane of said radial magnetic work-space; and wherein further said reciprocating element has an equatorial plane length at least twice the distance measured from the rotational axis to the center of said rotational element;
the magnetic rotational element and the at least one of a second reciprocating magnetic element provide a constant magnetic force there between without field cross-over, pass-by, disconnect, and without contact of said elements; wherein one continuously follows or actuates the other in response to a motive force.

15. The device of claim 14 wherein:
at least two reciprocating permanent magnet elements are provided and are circumferentially spaced for mutual and cooperating magnetic action.

16. The device of claim 15 wherein:
said at least two reciprocating elements are connected by a member there between.

17. The device of claim 14 wherein:
the radial work-space of said at least one magnetic rotational element is provided by a magnetic assembly having combined fields.

18. The device of claim 17 wherein:
said combined fields are constructed by at least two axially spaced magnets that provide a substantially unobstructed work-space along said equatorial plane.

19. The device of claim 14 wherein:
the magnetic field of said at least one reciprocating element is provided by a magnetic assembly having combined fields.

20. The device of claim 19 wherein:
said combined fields are constructed by at least two spaced apart magnets that provide a substantially unobstructed work-space along said equatorial plane.

21. The device of claim 14 wherein:
at least two of said devices are combined or grouped for mutual and cooperating magnetic action.

22. The device of claim 14 wherein:
said device is constructed in conjunction with a friction-based mechanical cam for assistive operation there between.
